(19) United States
(12) Patent Application Publication
(10) Pub. No.: US 2025/0370270 A1
(43) Pub. Date: Dec. 4, 2025

(54) VIDEO DISPLAY APPARATUS WITH PLURALITY OF ATTACHMENT POSITIONS

(71) Applicant: CANON KABUSHIKI KAISHA, Tokyo (JP)

(72) Inventor: TAKAMASA DEGAWA, Kanagawa (JP)

(21) Appl. No.: 19/224,415

(22) Filed: May 30, 2025

(30) Foreign Application Priority Data
Jun. 4, 2024 (JP) 2024-090828

(51) Int. Cl. G02B 27/01; G02B 27/00; H04R 1/02

(52) U.S. Cl. CPC G02B 27/0176; G02B 27/0093; G02B 27/0172; H04R 1/028; G02B 2027/0138; G02B 2027/014; G02B 2027/0154; G02B 2027/0163; G02B 2027/0169

(57) ABSTRACT

A video display apparatus includes a display unit that displays a video, and a support member configured to be connected to and rotatably support the display unit, wherein the display unit and the support member are selectively attachable to each other at one of a plurality of positions.

### BACKGROUND

### Field of the Technology

The present disclosure relates to a video display apparatus.

### Description of the Related Art

In recent years, a head mount display (HMD) apparatus that is mounted on a head of a user and displays a video in front of eyes of the user has been used as a video display apparatus. Because the HMD apparatus allows the user to easily enjoy large screen view of a video and facilitates stereoscopic vision, for example, the HMD apparatus is used as a device for providing experiences of virtual reality (VR) or mixed reality (MR).

Some HMD apparatuses are provided with a flip mechanism in which a rotation shaft disposed between a display main body and a head mounted device pivots to move a display main body in an upward direction and a lateral direction within a field of view. Further, Japanese Patent Application Laid-Open No. 2017-69736 discusses an HMD apparatus which is provided with ball joint mechanisms and changes a relative position between a display main body and a head mounted device with a high degree of freedom in order to avoid an influence of the rotation of the flip mechanism, such as a sense of discomfort on a user.

However, in the technique discussed in Japanese Patent Application Laid-Open No. 2017-69736, because the degree of freedom of movement of the relative position is too high, the user may have difficulty in appropriately adjusting the position of the display main body serving as a display unit. To stop the display main body at a desired position, parts for the ball joints are required. In order to smoothly move the display main body, the parts for the ball joints processed with high accuracy are needed, and there is a concern that the cost may increase.

### SUMMARY

In view of the above-described issue, the present disclosure is directed to providing a video display apparatus with a relatively simple configuration that allows a user to easily adjust a display unit to a desired position and observe a video without a sense of discomfort.

According to an aspect of the present disclosure, a video display apparatus includes a display unit that displays a video, and a support member configured to be connected to and rotatably support the display unit, wherein the display unit and the support member are selectively attachable to each other at one of a plurality of positions.

Further features of the present disclosure will become apparent from the following description of exemplary embodiments (with reference to the attached drawings).

### BRIEF DESCRIPTION OF THE DRAWINGS

FIG. 1 is a perspective view of a head mount display (HMD) apparatus according to an exemplary embodiment.

FIG. 2 is a perspective view of a display main body of the HMD apparatus according to the present exemplary embodiment.

FIG. 3 is a block diagram illustrating a configuration of various functions of a video display apparatus according to the present exemplary embodiment.

FIG. 4A is a perspective view of the front of a head mounted device of the video display apparatus according to the present exemplary embodiment. FIG. 4B is a perspective view of the back of the head mounted device of the video display apparatus according to the present exemplary embodiment. FIG. 4C is an enlarged view of a structure of a detachable hook.

FIG. 5A is a diagram illustrating a top view of the display main body. FIG. 5B is a cross-sectional view of a display side connection part taken along a dot-dash line I-I illustrated in FIG. 5A.

FIG. 6A is a top view of the HMD apparatus according to the present exemplary embodiment. FIG. 6B is a cross-sectional view of an attachment unit taken along a dot-dash line II-II illustrated in FIG. 6A in a state where the head mounted device is attached to the display main body.

FIG. 7A is a diagram schematically illustrating an effect of a configuration in which a front connection part and a rear connection part are disposed at positions different from each other in a vertical direction. FIG. 7B is a diagram schematically illustrating a position of the display main body in case where a head mounted device side connection part is connected and attached to the rear connection part. FIG. 7C is a diagram schematically illustrating a change in a position of the display main body when a vertical position of the display main body is adjusted.

FIG. 8A is a diagram schematically illustrating a case where a user having a first type face shape wears an HMD apparatus according to a comparative example. FIG. 8B is a diagram schematically illustrating a case where a user having a second type face shape wears the HMD apparatus according to the comparative example.

FIG. 9A is a diagram schematically illustrating a case where the user having the first type face shape wears the HMD apparatus with the head mounted device side connection part attached to the front connection part in the present exemplary embodiment. FIG. 9B is a diagram schematically illustrating a case where the user having the second type face shape wears the HMD apparatus with the head mounted device side connection part attached to the rear connection part in the present exemplary embodiment.

FIG. 10A is a diagram schematically illustrating a state in which a recommended attachment position is displayed to the user having the first type face shape. FIG. 10B is a diagram schematically illustrating a state in which a recommended attachment position is displayed to the user having the second type face shape.

FIG. 11A is a diagram schematically illustrating a state in which the recommended attachment position suitable for the first type face shape is displayed using a detection switch. FIG. 11B is a diagram schematically illustrating a state in which the recommended attachment position suitable for the second type face shape is displayed using the detection switch. FIG. 11C is a flowchart illustrating a procedure of a function of displaying a recommended attachment position.

FIG. 12A is a perspective view of a handheld support member connected to a display main body. FIG. 12B is an enlarged sectional view of a connection part in the state illustrated in FIG. 12A.

FIG. 13A illustrates a top view of a display main body according to a modification example of the present exemplary embodiment. FIG. 13B is a cross-sectional view of a display side connection part taken along a dot-dash line I-I illustrated in FIG. 13A.

### DESCRIPTION OF THE EMBODIMENTS

Hereinafter, a specific exemplary embodiment of the present disclosure will be described in detail with reference to drawings. In the present exemplary embodiment, a direction perpendicular to a user's frontal plane is defined as a depth direction, a direction perpendicular to a user's sagittal plane is defined as a lateral direction, a direction normal to a horizontal plane is defined as a vertical direction, and a direction of an optical axis of an eyepiece 103 of a display main body 101 is defined as an optical axis direction.

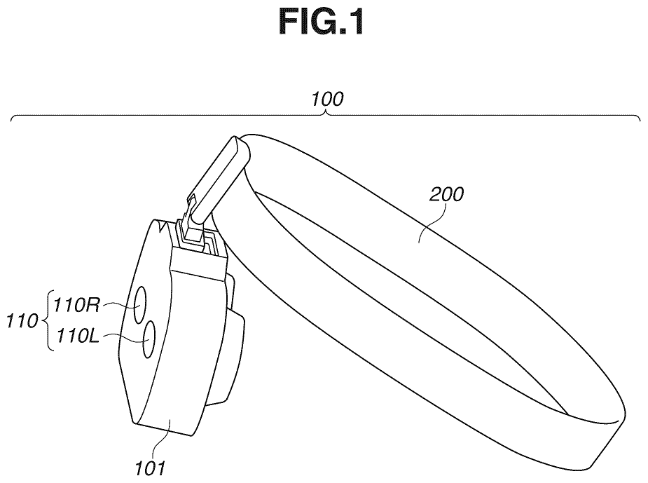

FIG. 1 is a perspective view of a head mount display (HMD) apparatus 100 according to the present exemplary embodiment.

A video display apparatus according to the present exemplary embodiment is a so-called HMD type apparatus. The HMD apparatus 100 includes the display main body 101 serving as a display unit of a video and a head mounted device 200 serving as a support member that is connected to the display main body 101 and rotatably supports the display main body 101.

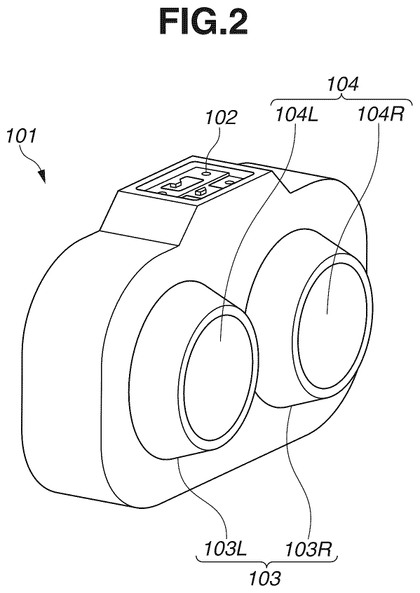

FIG. 2 is a perspective view of the display main body 101 of the HMD apparatus 100 according to the present exemplary embodiment.

The display main body 101 includes an imaging camera 110, a display side connection unit 102 which is a first connection unit, and the eyepiece 103. The imaging camera 110 includes a right imaging camera 110R and a left imaging camera 110L matching the right and left eyes of a user, respectively. The display side connection unit 102 is a connection unit (first connection unit) to which a head mounted device side connection unit 202 described below is attachable and which connects to the head mounted device 200, and is disposed at a substantially center part of an upper part of the imaging camera 110. The eyepiece 103 includes a left eyepiece 103L and a right eyepiece 103R. The eyepiece 103 includes a display lens 104, and screens displayed on display panels 106 (not illustrated in FIG. 2) disposed inside the left eyepiece 103L and the right eyepiece 103R can be formed at a predetermined position by the display lens 104. The display lens 104 includes a left display lens 104L and a right display lens 104R.

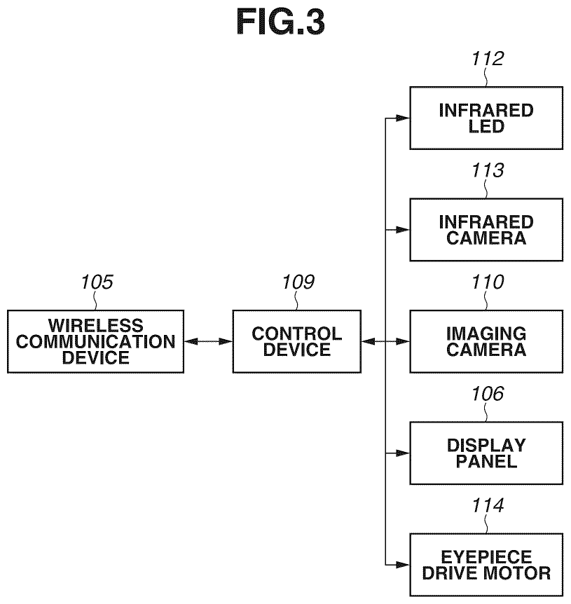

FIG. 3 is a block diagram illustrating a configuration of various functions of the video display apparatus according to the present exemplary embodiment. FIG. 3 illustrates a display panel 106, a control device 109, the imaging camera 110, an infrared light emitting diode (LED) 112, an infrared camera 113, an eyepiece drive motor 114, and a wireless communication device 105.

The display main body 101 of FIG. 2 includes the control device 109. The control device 109 includes, for example, a central processing unit (CPU) and controls entire operation of the display main body 101. While, in the present exemplary embodiment, the control device 109 is built in the display main body 101, the control device 109 may be an external computer or may be configured to be a function implemented in collaboration with an external computer and the display main body 101.

The display main body 101 further includes the wireless communication device 105 for communicating with a predetermined external device to transmit and receive data.

The eyepiece 103 of FIG. 2 has an interpupillary distance adjustment function that moves the left display lens 104L and the right display lens 104R in the lateral direction to adjust a distance between optical axes of the left display lens 104L and the right display lens 104R to the interpupillary distance which is a width between the right and left eyeballs of the user. The interpupillary distance adjustment function may be realized by a configuration in which the left display lens 104L and the right display lens 104R are manually operated using a slide rail or the like or are electrically adjusted using the eyepiece drive motor 114. The eyepiece drive motor 114 is a drive motor for realizing the interpupillary distance adjustment function of the eyepiece 103.

The eyepiece 103 further has an eyeball position measurement function. The eyeball position measurement function is a function of measuring distances from the eyeballs with respect to the display lens 104 in the vertical direction and the lateral direction by irradiating the eyeballs with the infrared LED 112 and capturing an image with the infrared camera 113. The control device 109 calculates the amount of movement of the left eyepiece 103L and the right eyepiece 103R from a measurement result of the eyeball position measurement function and controls the interpupillary distance adjustment function to adjust the interpupillary distance between the left eyepiece 103L and the right eyepiece 103R.

The control device 109 controls operation of the infrared LED 112 and the infrared camera 113 to obtain an image of the eyeballs. Further, the control device 109 is able to obtain an image of the front from the imaging camera 110 and display the image on the display panel 106. The control device 109 is also able to control the eyepiece drive motor 114 to automatically adjust the interpupillary distance. Furthermore, the control device 109 uses the wireless communication device 105 to communicate with an external computer to perform data processing.

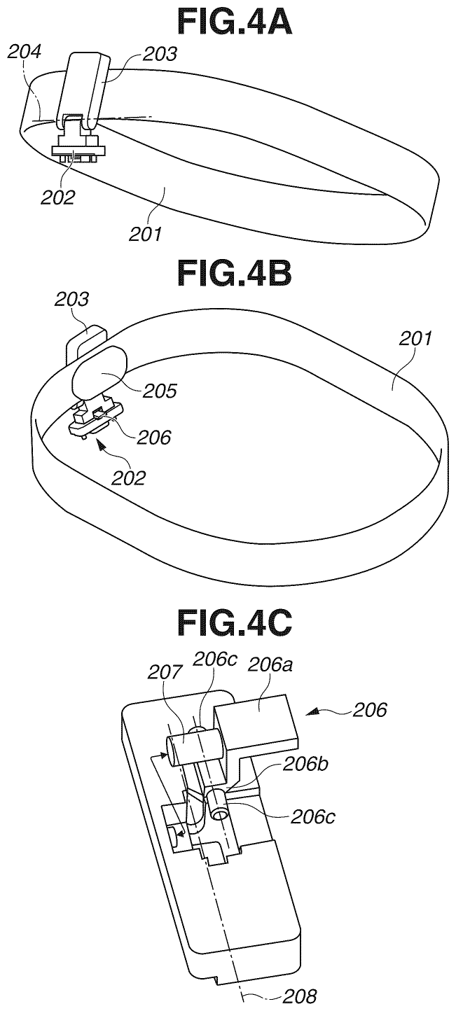

FIGS. 4A to 4C are perspective views of the head mounted device 200 of the video display apparatus in the present exemplary embodiment. FIG. 4A mainly illustrates the front of the head mounted device 200, FIG. 4B mainly illustrates the back of the head mounted device 200, and FIG. 4C illustrates a structure of a detachable hook 206 in an enlarged manner.

The head mounted device 200 includes a mounting ring 201, the head mounted device side connection unit 202 serving as a second connection unit, a vertical position adjustment mechanism 203, a display rotation shaft 204, a head pad 205, and the detachable hook 206 which is an attachment unit to the display side connection unit 102.

The mounting ring 201 has a function of supporting the display main body 101 on the head of the user to prevent the display main body 101 from moving. The mounting ring 201 has an extension mechanism (not illustrated) and is contracted after the head of the user is passed through the mounting ring 201 with the extension mechanism extended, so that the mounting ring 201 is attached to the head of the user. The extension and contraction may be configured to be performed by electric power using a predetermined drive motor or may be configured to be performed manually by the user using a dial. A pair of speakers (not illustrated) are disposed at predetermined left and right positions on the mounting ring 201. Since the speakers are disposed on the left and right sides, the user can enjoy stereo sound. Depending on performance of the speakers, the speakers may function as a spatial audio.

The vertical position adjustment mechanism 203 of the display main body 101 is used to move the optical axis of the display main body 101 in the substantially vertical direction with respect to the eyeballs in a state where the HMD apparatus 100 is mounted on the user's head. In the present exemplary embodiment, the vertical position adjustment mechanism 203 is worn along the forehead of the user, and therefore, when the display main body 101 is adjusted upward, the display main body 101 also moves rearward, and when the display main body 101 is adjusted downward, the display main body 101 also moves forward. The vertical position adjustment mechanism 203 may be configured to be electrically operated by using a predetermined drive motor or may be configured to be manually operated by the user with a dial.

The display rotation shaft 204 includes a hinge mechanism that requires a predetermined torque to be pivoted.

Since the display rotation shaft 204 requires a predetermined torque to be pivoted, the user can manually adjust the position of the display main body 101, and the position of the display main body 101 is maintained after the adjustment. As the hinge mechanism, a hinge mechanism having a click mechanism may be used. A lock mechanism may also be used separately to maintain the position of the display main body 101.

The head pad 205 is used as a pad that comes into contact with the forehead of the user when the mounting ring 201 is attached to the head.

The detachable hook 206 is operated by the user so that the display main body 101 and the head mounted device 200 are attached to and released from each other. As illustrated in FIG. 4C, the detachable hook 206 includes an operation part 206a of the detachable hook 206, a hook part 206b, a detachable hook shaft 206c, a biasing spring 207, and a hook rotation shaft 208. In the detachable hook 206, the operation part 206a rotates about the hook rotation shaft 208. The operation part 206a is biased by the biasing spring 207 so as to be attached, and the user can release the attachment by operating the operation part 206a.

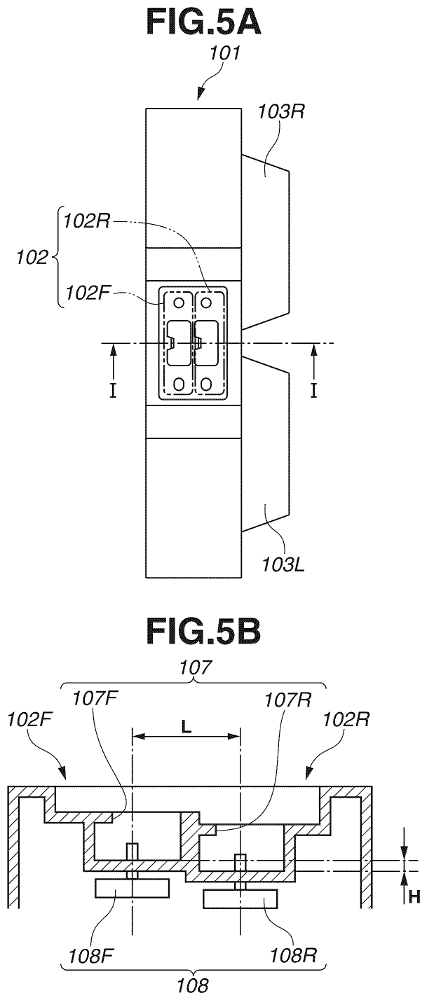

FIGS. 5A and 5B are diagrams schematically illustrating the display side connection unit 102 disposed at the display main body 101. FIG. 5A is a top view of the display main body 101, and FIG. 5B is a cross-sectional view of the display side connection unit 102 taken along a dot-dash line I-I illustrated in FIG. 5A.

The display side connection unit 102 is configured in such a manner that the head mounted device side connection unit 202 of the head mounted device 200 is able to be attached to the display side connection unit 102 at a plurality of discrete attachment positions. Specifically, the display side connection unit 102 includes a front connection part 102F and a rear connection part 102R serving as two connection parts as indicated by two-dot chain lines illustrated in FIG. 5A. The front connection part 102F is arranged in the front in the depth direction viewed from the user, and the rear connection part 102R is arranged in the rear in the depth direction viewed from the user. In the display side connection unit 102, the head mounted device side connection unit 202 of the head mounted device 200 is selectively attached to one of the front connection part 102F and the rear connection part 102R.

A method of attaching the head mounted device side connection unit 202 to the display side connection unit 102 will be described with reference to FIG. 5B.

The display side connection unit 102 is provided with an attachment unit 107. Specifically, a front attachment part 107F is disposed at the front connection part 102F, and a rear attachment part 107R is disposed at the rear connection part 102R. A length between the front attachment part 107F and the rear attachment part 107R in the depth direction is L, and a length between the front attachment part 107F and the rear attachment part 107R in the vertical direction is H. The display main body 101 and the head mounted device 200 are connected and attached to each other by the detachable hook 206 of the head mounted device 200 and the front attachment part 107F or the rear attachment part 107R engaging with each other.

A detection switch 108 includes a front detection switch 108F and a rear detection switch 108R. The front detection switch 108F is supported to the front connection part 102F, and a rear detection switch 108R is supported to the rear connection part 102R by respective components (not illustrated).

The front connection part 102F and the rear connection part 102R are disposed at positions different from each other in the vertical direction, and the front connection part 102F is positioned higher than the rear connection part 102R. In this configuration, the front attachment part 107F is positioned higher than the rear attachment part 107R.

In a case where the head mounted device side connection unit 202 is connected to the display side connection unit 102 (e.g., the front connection part 102F), for example, the detachable hook 206 comes into contact with the detection switch 108 (e.g., the front detection switch 108F), and conduction is established. The control device 109 uses a function serving as a connection detection unit to detect the conduction in the detection switch 108, whereby a current attachment position of the display side connection unit 102 to the head mounted device side connection unit 202 is detected.

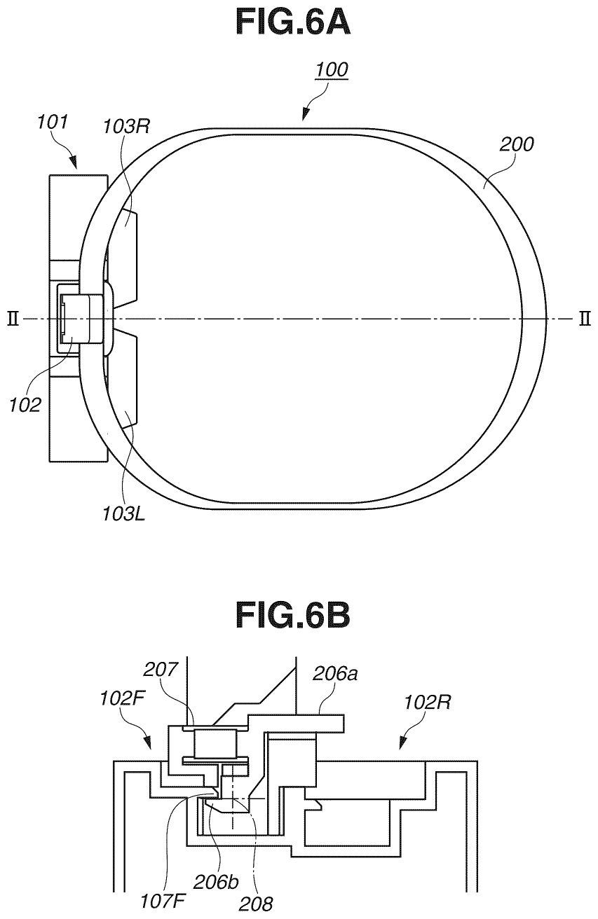

FIGS. 6A and 6B are diagrams schematically illustrating a state in which the head mounted device 200 is attached to the display main body 101. FIG. 6A is a top view of the HMD apparatus 100, and FIG. 6B is a cross-sectional view of the attachment unit 107 taken along a dot-dash line II-II illustrated in FIG. 6A in a state in which the head mounted device side connection unit 202 is attached to the display side connection unit 102 (here, the front attachment part 107F).

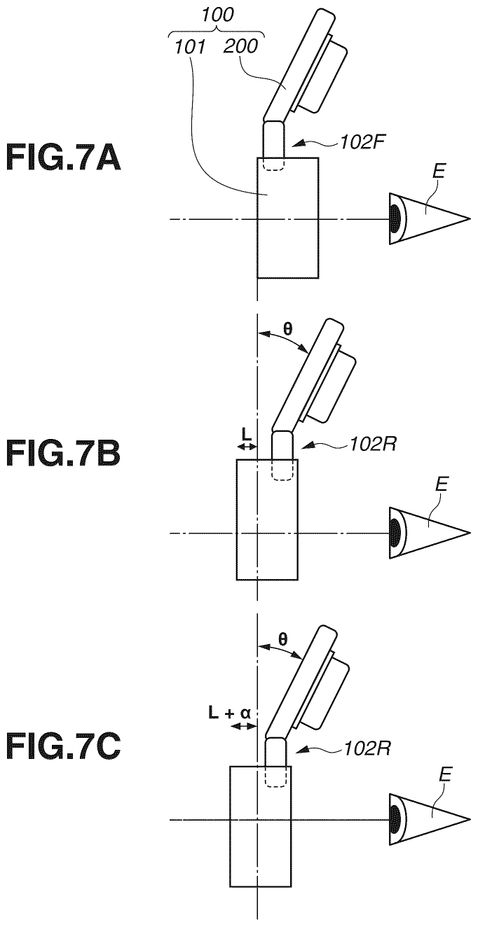

The detachable hook 206 is biased in a clockwise (CW) direction in FIG. 7B by the biasing spring 207 and engages with the attachment unit 107 (here, the front attachment part 107F), and the display main body 101 and the head mounted device 200 are releasably attached to each other. In this state, the hook part 206b of the detachable hook 206 engages with the front attachment part 107F. When the user wants to release the attachment, the user operates the operation part 206a around the hook rotation shaft 208, so that the engagement is released.

While the present exemplary embodiment is configured such that the head mounted device side connection unit 202 is attached to the display side connection unit 102 by the detachable hook 206, a different configuration may be employed. Further, a lid like a separate component may be fitted and attached to one of the front connection part 102F and the rear connection part 102R to which the head mounted device side connection unit 202 is not connected. By adding the lid as a separate component, there is an effect of covering a positioning part and the attachment unit which are not connected, which can improve the design. On the other hand, because there is a possibility that the lid is lost or it is relatively difficult to secure the attachment strength, it is desirable that the configuration be appropriately selected according to the required specification.

FIGS. 7A to 7C are diagrams schematically illustrating an effect obtained by the front connection part 102F and the rear connection part 102R disposed at positions different from each other in the vertical direction.

In the present exemplary embodiment, for example, in a case where the head mounted device side connection unit 202 is connected and attached to the front connection part 102F, the positions of eyeballs E of the user and the eyepiece 103 in the vertical direction are designed to coincide with each other. This state is illustrated in FIG. 7A. As illustrated in FIG. 7B, in a case where the head mounted device side connection unit 202 is attached to the rear connection part 102R, the display main body 101 is disposed at a position which is separated from the eyeballs E by the length L in the depth direction and by the length H in the vertical direction from the position illustrated in FIG. 7A. In this state, since the display main body 101 is shifted upward from the eyeballs E, the user appropriately adjusts the vertical position downward using the vertical position adjustment mechanism 203. In this state, in a case where a driving direction of the display main body 101 by the vertical position adjustment mechanism 203 is inclined by θ, the display main body 101 is further separated from the eyeballs E by α as illustrated in FIG. 7C. The distance α is represented by the following formula.

$$α = H \cdot tan θ$$

By adopting the above-described configuration, the distance difference in the depth direction for use is adjustable by greater than or equal to the pitch of the display side connection unit 102 (greater than or equal to the length L between the front connection part 102F and the rear connection part 102R in the depth direction). This may lead to a reduction in a thickness of the display main body 101. In this configuration, the rear connection part 102R is configured to occupy some internal space of the display main body 101 in the vertical direction, and thus, a larger internal space is required in some cases. Therefore, it is necessary to design the display main body 101 in consideration of its internal mechanical structure.

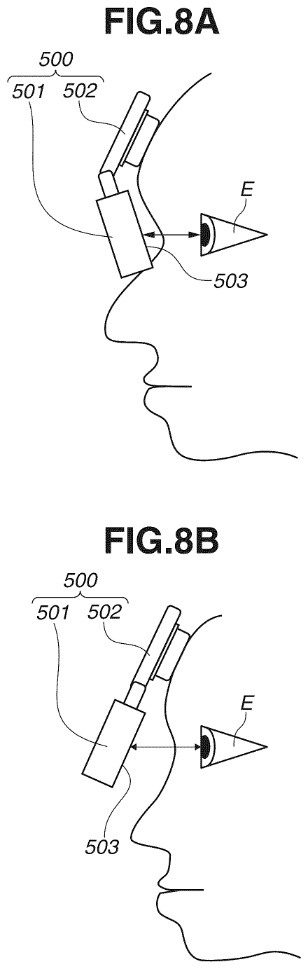

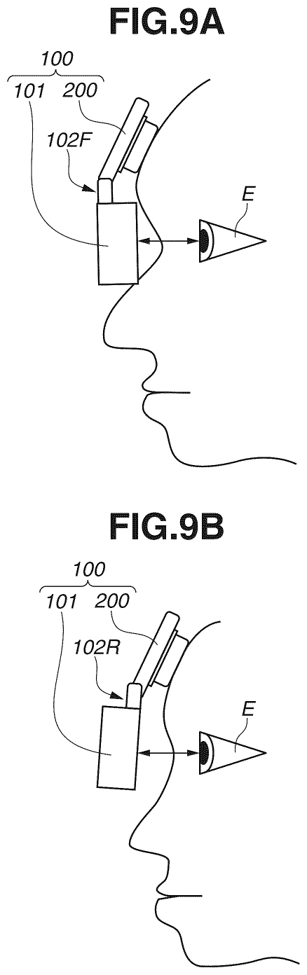

Here, an effect achieved in the HMD apparatus 100 of the present exemplary embodiment will be described based on comparison with a comparative example. FIGS. 8A and 8B are diagrams illustrating an HMD apparatus 500 according to the comparative example, and FIGS. 9A and 9B are diagrams illustrating the effect of the HMD apparatus 100 according to the present exemplary embodiment.

The HMD apparatus 500 of the comparative example includes, similarly to the HMD apparatus 100 of the present exemplary embodiment, a display main body 501 and a head mounted device 502 in which a ring-shaped band is configured to be extendable, and is configured to pivot the display main body 501 by a flip mechanism. On the other hand, the HMD apparatus 500 of the comparative example is different from the HMD apparatus 100 of the present exemplary embodiment in that only one connection part to which the head mounted device side connection part of the head mounted device 502 is connected and attached is provided in an upper part of the display main body 501.

FIG. 8A illustrates a case where a user having a face structure with deep-set features and a high-bridged nose (hereinafter referred to as a first type face shape), such as a Caucasian face, wears the HMD apparatus 500. FIG. 8B illustrates a case where a user having a face shape with shallow-set features and a low-bridged nose (hereinafter referred to as a second type face shape), such as a Mongoloid face, wears the HMD apparatus 500.

In the case of the first type face shape, the head mounted device 502 is mounted toward the front with respect to the eyeballs E, and thus, it is necessary to pivot the display main body 501 in a counterclockwise (CCW) direction as illustrated in FIG. 8A to bring an eyepiece 503 close to the eyeballs E. In the case of the second type face shape, the head mounted device 502 is mounted toward the face with respect to the eyeballs E, and thus, it is necessary to pivot the display main body 501 in the CW direction as illustrated in FIG. 8B to move the eyepiece 503 away from the eyeballs E. Depending on a position of a display rotation shaft 204, the angular difference between FIGS. 8A and 8B may be large, which may give a sense of discomfort to the user.

FIG. 9A illustrates a case where the user having the first type face shape connects and attaches the head mounted device side connection unit 202 to the front connection part 102F and wears the HMD apparatus 100.

FIG. 9B illustrates a case where the user having the second type face shape connects and attaches the head mounted device side connection unit 202 to the rear connection part 102R and wears the HMD apparatus 100.

In the HMD apparatus 100 according to the present exemplary embodiment, one of the front connection part 102F and the rear connection part 102R is appropriately selected according to the face shape in the display side connection unit 102 to which the head mounted device side connection unit 202 is connected. In this way, by shifting the connection part with the head mounted device side connection unit 202 in the depth direction, the inclination difference of the display main body 101 due to the difference in the face shape is able to be reduced.

It is desirable that the distance (pitch) between the front connection part 102F and the rear connection part 102R adjacent to each other be set in accordance with the distance difference between the forehead and the eyeballs of the first and second type face shapes in the depth direction. For example, in a case of a Mongoloid and a Caucasian, the distance difference between the forehead and the eyeballs is considered to be about 10 millimeters (mm) on average. If the pitch in the depth direction is set to be greater than 10 mm, the display rotation shaft 204 is used in an adjustment of a distance greater than 5 mm in a case of a face shape having a distance between the forehead and the eyeballs of mixed features between the first and second type face shapes. This may lead to an increase in an inclination of the display main body 101. On the other hand, if the pitch is set to be less than 5 mm, the inclination of the display main body 101 may be increased depending on individual differences, for example, with a face shape having the forehead and the eyeballs further away from each other or closer to each other, even in the first and second type face shapes. Therefore, in order to use the HMD apparatus 100 with less discomfort for more users, the pitch between the connection parts is desirably set greater than 5 mm and less than 10 mm.

By adopting the above-described configuration, even in a case where the display rotation shaft 204 is used to adjust the display main body 101 in the depth direction, the adjustment in the depth direction is able to be performed while an increase in the inclination of the display main body 101 is suppressed. Because each part of the attachment unit 107 is configured without using a special component, the number of components is reduced, and the HMD apparatus 100 is configured to be small and light. As described above, with the HMD apparatus 100 according to the present exemplary embodiment, the user can easily adjust the distance between the display main body 101 and the eyeballs in the optical axis direction to reduce the inclination of the display main body 101 with a relatively simple configuration. Thus, the user can adjust the display main body 101 to a desired position and observe a video without a sense of discomfort.

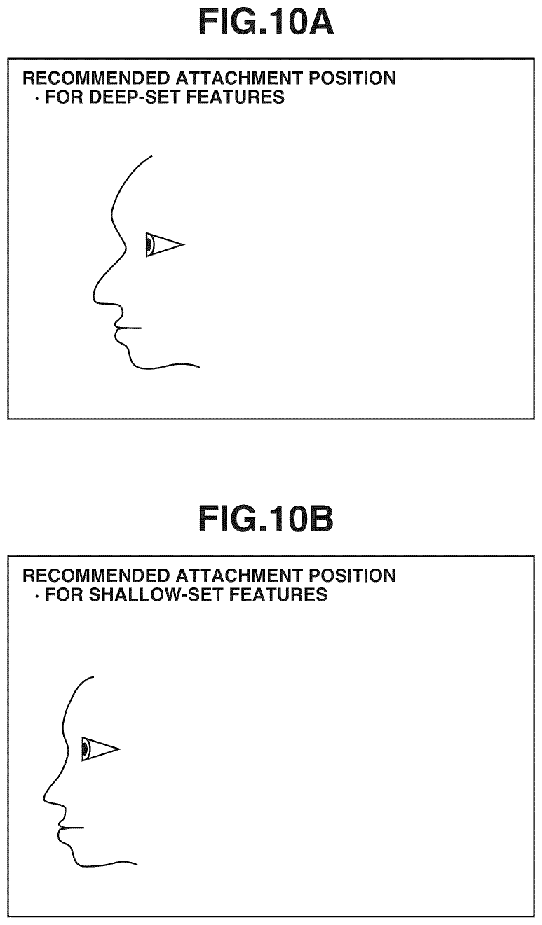

FIGS. 10A and 10B are diagrams illustrating examples of recommended attachment positions which are indicated by displaying a face shape, and FIG. 10A illustrates a case of a face shape matching the first type face shape, and FIG. 10B illustrates a case of a face shape matching the second type face shape.

A case where the display main body 101 and the head mounted device 200 are attached to each other at the front connection part 102F is suitable for the first type face shape, such as a Caucasian face shape, in which the distance between the forehead and the eyeballs in the depth direction is long. A case where the display main body 101 and the head mounted device 200 are attached to each other at the rear connection part 102R is suitable for the second type face shape, such as a Mongoloid face shape, in which the distance between the forehead and the eyeballs in the depth direction is short.

The control device 109 is able to determine a suitable attachment position matching with a face shape by a function serving as a determination unit from a detection result of the current attachment position of the display side connection unit 102 with the head mounted device side connection unit 202 that has been obtained by the connection detection unit described above. In a case where the control device 109 detects that the attachment is performed at the front attachment part 107F, the control device 109 notifies the user that the attachment is performed at the position with the distance between the forehead and the eyeballs in the depth direction suitable for the first type face shape, by the function of the control device 109 serving as a notification unit. In this processing, the display panel 106 of the eyepiece 103 displays, for example, an image as illustrated in FIG. 10A. In a case where the control device 109 detects that the attachment is performed the rear attachment part 107R, the user is notified that the attachment is performed at the position with the distance between the forehead and the eyeballs in the depth direction suitable for the second type face shape. In this processing, the display panel 106 of the eyepiece 103 displays an image as illustrated in FIG. 10B. By adopting the above-described configuration, the user is notified which face shape type the current attachment position of the attachment unit 107 is suitable for, and thus the user can avoid using the HMD apparatus 100 with a disadvantageous attachment position at which the user feels discomfort.

An initial position of the interpupillary distance in the interpupillary distance adjustment function may be changed in accordance with the detection result of the current attachment position of the display side connection unit 102 with the head mounted device side connection unit 202 obtained by the detection switch 108. For example, the second type face shape tends to have a wider eye width than the first type face shape. Thus, in a case where the head mounted device 200 is attached to the rear connection part 102R, it is desirable to set an operation start position of the interpupillary distance adjustment function to be wide in the lateral direction. By adopting the above-described configuration, it is expected that an adjustment time using the interpupillary distance adjustment function is averagely shortened.

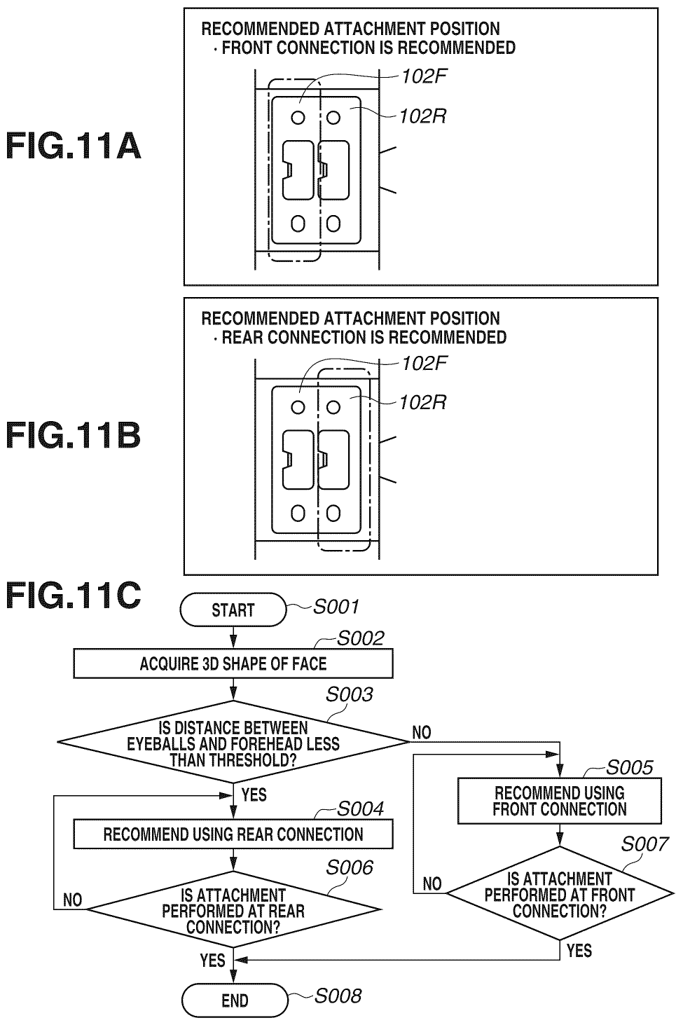

FIGS. 11A to 11C are diagrams illustrating an example of a function that displays a recommended attachment position of the display main body 101 by using the detection switch 108. FIG. 11A illustrates a case in which a face shape matches the first type face shape, FIG. 11B illustrates a case where a face shape matches the second type face shape, and FIG. 11C illustrates a flowchart of the function.

In the present exemplary embodiment, as illustrated in FIG. 1, the display main body 101 has the imaging camera 110. The control device 109 has a function serving as a face shape measurement unit, and in response to each camera of the imaging camera 110 capturing the face shape, the control device 109 performs image analysis, and a three-dimensional face shape is acquired. A method of acquiring a three-dimensional face shape by using two cameras is a known technique, and thus the detailed description is omitted.

The control device 109 measures a predetermined distance between the eyeballs and the forehead in the depth direction in the three-dimensional face shape acquired by a function serving as a distance measurement unit. In a case where the distance between the eyeballs and the forehead in the depth direction is more than a predetermined threshold, the control device 109 displays a message recommending the user to perform the attachment at the front attachment part 107F, on the display panel 106 of the eyepiece 103 by a function serving as an attachment position recommending unit as illustrated in FIG. 11A. On the other hand, in a case where the distance between the eyeballs and the forehead in the depth direction is smaller than the predetermined threshold, the control device 109 displays a message recommending the user to perform the attachment at the rear attachment part 107R, on the display panel 106 of the eyepiece 103 as illustrated in FIG. 11B. In a case where the distance between the eyeballs and the forehead in the depth direction is equal to the predetermined threshold, the user may choose either to perform the attachment at the front attachment part 107F or at the rear attachment part 107R. The function of the display main body 101 as the attachment position recommending unit for recommending the attachment position to the user may be automatically started after power supply is started, or may be started in response to a selection performed by the user via a predetermined menu screen.

A procedure of the function of the attachment position recommending unit will be described. As illustrated in FIG. 11C, in step S001, the procedure starts, and the processing proceeds to step S002. In step S002, a three-dimensional face shape image of the user is acquired. The three-dimensional face shape image may be acquired by using the imaging camera 110 of the display main body 101 or a different electronic device, such as a mobile terminal.

After acquisition of the three-dimensional face shape image in step S002, the processing proceeds to step S003. In step S003, the control device 109 acquires the predetermined distance between the eyeballs and the forehead of the user in the depth direction, and the control device 109 determines whether the distance is larger or smaller than the predetermined threshold. In a case where the control device 109 determines that the predetermined distance is smaller than the predetermined threshold (YES in step S003), the processing proceeds to step S004. In a case where the control device 109 determines that the predetermined distance is larger than the predetermined threshold (NO in step S003), the processing proceeds to step S005.

In step S004, the control device 109 displays a message recommending the user to attach the head mounted device 200 to the rear connection part 102R, on the display panel 106 of the eyepiece 103, and the processing proceeds to step S006. In step S006, the control device 109 determines whether the head mounted device 200 is attached to the front connection part 102F or the rear connection part 102R, based on the detection result of the detection switch 108. In a case where the control device 109 determines that the head mounted device 200 is attached to the rear connection part 102R (YES in step S006), the processing proceeds to step S008, and the procedure is ended. In a case where the control device 109 determines that the head mounted device 200 is attached to the front connection part 102F (NO in step S006), the processing returns to step S004.

In step S005, the control device 109 displays a message recommending the user to attach the head mounted device 200 to the front connection part 102F, on the display panel 106 of the eyepiece 103, and the processing proceeds to step S007. In step S007, the control device 109 determines whether the head mounted device 200 is attached to the front connection part 102F or the rear connection part 102R, based on the detection result of the detection switch 108. In a case where the control device 109 determines that the head mounted device 200 is attached to the front connection part 102F (YES in step S007), the processing proceeds to step S008, and the procedure is ended. In a case where the control device 109 determines that the head mounted device 200 is attached to the rear connection part 102R (NO in step S007), the processing returns to step S005.

When the processing returns from step S007 to step S005 and from step S006 to step S004, the recommended attachment position may be displayed on the display panel 106 of the eyepiece 103 as illustrated in FIGS. 11A and 11B. By adopting the above-described configuration, the user is notified of the attachment position that is recommended based on the user's face shape, and thus the user can avoid using the HMD apparatus 100 at a disadvantageous attachment position at which the user feels discomfort.

In the HMD apparatus 100, an arrangement position of the speakers in the head mounted device 200 is adjustable by using the detection switch 108.

Depending on the user's facial shape, relative positions between the speakers and user's ears may vary. In general, the first type face shape is narrower in the lateral direction than the second type face shape. Thus, in a case where the user having the first type face shape wears the HMD apparatus 100, the speakers and the ears in the head mounted device tends to be separated by distance in the lateral direction in comparison with a case where the user having the second type face shape wears the HMD apparatus 100.

When multiple speakers are used to enhance sound effects, positions of the ears with respect to the speakers is an important parameter. In the display main body 101 according to the present exemplary embodiment, the control device 109 is able to determine whether the face shape of the user is the first type face shape or the second type face shape, by using the detection switch 108. In a case where the front detection switch 108F is opened or closed, the control device 109 determines that the user have a face shape closer to the first type face shape, and it is desirable to change the positions of the speakers to positions closer to the center of the head. On the other hand, in a case where the rear detection switch 108R is opened or closed, the control device 109 determines that the user has a face shape closer to the second type face shape, and it is desirable to change the positions of the speakers to positions away from the center of the head. By adopting the above-described configuration, the acoustic effect in the HMD apparatus 100 is enhanced.

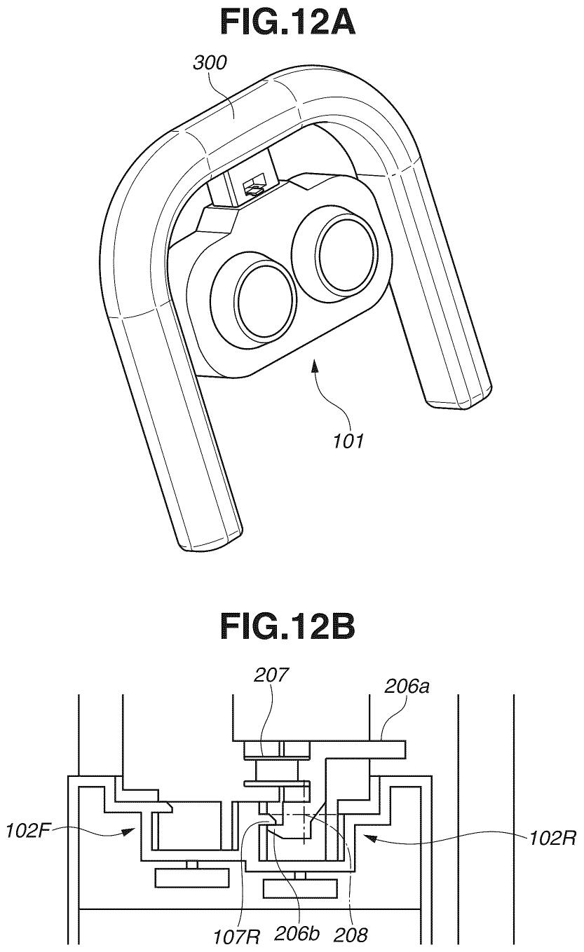

FIGS. 12A and 12B are diagrams schematically illustrating a case in which a handheld support member is connected to the display main body 101. FIG. 12A illustrates a perspective view of the overall apparatus, and FIG. 12B illustrates an enlarged cross-sectional view of the connection part.

Instead of the head mounted device 200, a handheld device 300 is also attachable to the display main body 101 according to the present exemplary embodiment. In a case where the handheld device 300 is used, if the interpupillary distance adjustment function according to the present exemplary embodiment is executed, a movement of hands is detected, which results in difficulty in adjusting the interpupillary distance to a correct position. Thus, it is desirable that the interpupillary distance adjustment function be not executed in a case where the handheld device 300 is attached.

The handheld device 300 includes two connection pars, one of which is connectable to the front connection part 102F and the other to the rear connection part 102R. Thus, both the front detection switch 108F and the rear detection switch 108R are opened or closed simultaneously. By adopting this configuration, the control device 109 is able to simultaneously detect the opening or closing of both the front detection switch 108F and the rear detection switch 108R and detect that the handheld device 300 is attached.

The handheld device 300 is provided with a detachable hook 206 and a biasing spring 207. A hook part 206b is disposed at a position corresponding to the rear connection part 102R. The hook part 206b is disposed at the rear part because this configuration allows the user to easily operate an operation part 206a. By adopting the above-described configuration, operation and the user interface are able to be changed in accordance with the type of a mounted device attached to the display main body 101, which improves convenience of the user.

### Modification Example

A modification example of the present exemplary embodiment is described below. In the present modification example, an HMD apparatus similarly to the present exemplary embodiment will be described but is different from the present exemplary embodiment in that the structure of a connection part of a display main body is different.

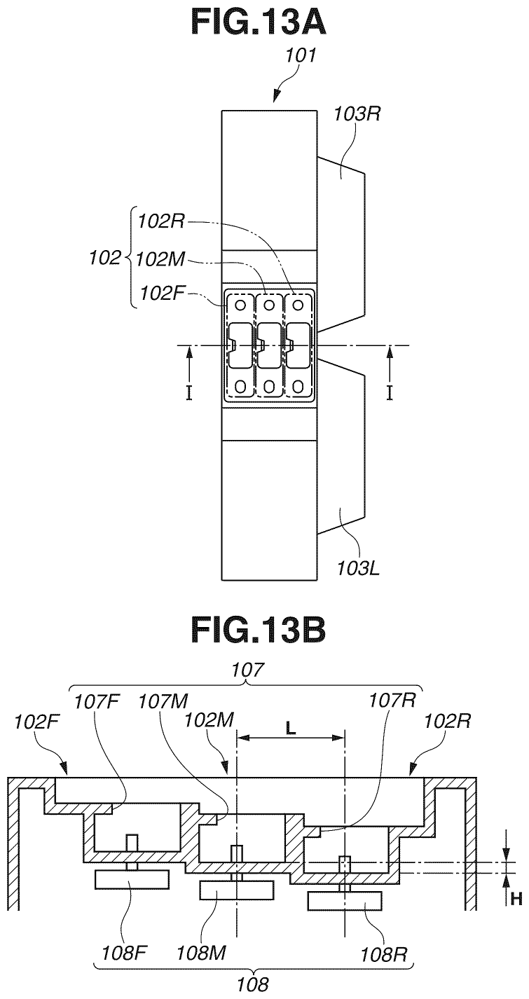

FIGS. 13A and 13B are diagrams schematically illustrating a display side connection unit 102 disposed at the display main body 101 according to the present modification example. FIG. 13A illustrates a top view of a display main body 101, and FIG. 1B illustrates a cross-sectional view of the display side connection unit 102 taken along a dot-dash line I-I illustrated in FIG. 13A.

A head mounted device side connection unit 202 of a head mounted device 200 is attachable to the display side connection unit 102 at a plurality of discrete attachment positions. Specifically, as indicated by two-dot chain lines in FIG. 13A, the display side connection unit 102 includes three connection parts including a front connection part 102F, a center connection part 102M, and a rear connection part 102R. When viewed from the user, the front connection part 102F is arranged in the front, the center connection part 102M is arranged in the center, and the rear connection part 102R is arranged in the rear, in the depth direction. In the display side connection unit 102, the head mounted device side connection unit 202 of the head mounted device 200 is selectively attachable to one of the front connection part 102F, the center connection part 102M, and the rear connection part 102R.

A method of attaching the head mounted device side connection unit 202 to the display side connection unit 102 will be described with reference to FIG. 13B.

The display side connection unit 102 is provided with an attachment unit 107. Specifically, a front attachment part 107F is arranged in the front, a center attachment part 107M is arranged in the center, and a rear attachment part 107R is arranged in the rear. Distances between the front attachment part 107F and the center attachment part 107M and between the center attachment part 107M and the rear attachment part 107R in the depth direction are both L, and distances in the vertical direction between them are both H. The display main body 101 and the head mounted device 200 are connected and attached to each other by the detachable hook 206 of the head mounted device 200 and the front attachment part 107F, the center attachment part 107M, or the rear attachment part 107R engaging with each other.

The detection switch 108 includes a front detection switch 108F, a center detection switch 108M, and a rear detection switch 108R. The front detection switch 108F is supported to the front connection part 102F, the center detection switch 108M is supported to a center connection part 102M, and a rear detection switch 108R is supported to the rear connection part 102R, by respective components (not illustrated). The front connection part 102F, the center connection part 102M, and the rear connection part 102R are disposed at positions different from each other in the vertical direction. The front connection part 102F is positioned higher than the center connection part 102M, and the center connection part 102M is positioned higher than the rear connection part 102R. In this configuration, the front attachment part 107F is positioned higher than the center attachment part 107M, and the center attachment part 107M is positioned higher than the rear attachment part 107R.

Some users may have a face shape corresponding to mixed features between the first type face shape represented by a Caucasian and the second type face shape represented by a Mongoloid. In the present modification example, in addition to the front connection part 102F suitable for the first type face shape and the rear connection part 102R suitable for the second type face shape, the center connection part 102M suitable for a face shape corresponding to mixed features between the first and second type face shapes is provided. By adopting this configuration, the HMD apparatus 100 which is finely adapted to a face shape of the user and is easy to use is realized.

According to the HMD apparatus 100 of the present modification example, with the relatively simple configuration, the user can easily adjust the display main body 101 to a desired position and observe a video without a sense of discomfort.

While, in the present exemplary embodiment and the modification example, the descriptions have been given of the case where the attachment positions of the head mounted device side connection unit 202 are discretely provided in the display side connection unit 102, that is, two positions in the present exemplary embodiment and three positions in the modification example, the present disclosure is not limited thereto. For example, four or more discrete attachment positions may be provided, and furthermore, the attachment position may be changed in a continuous manner. As a configuration capable of continuously changing the attachment position, for example, a configuration including a rail and a lock mechanism that are combined to continuously move the head mounted device side connection part with respect to the display side connection part and attach the head mounted device side connection part at a desired position may be adopted. In this case, in order to obtain the effect described with reference to FIGS. 11A to 11C, the rail is desirably inclined with respect to the optical axis direction. In a case of continuously changing the attached position, it is desirable to replace the detection switch 108 with an encoder capable of detecting the attachment position in the linear direction, but this leads to an increase in space and a component cost, and therefore, it is desirable to select the configuration according to the required performance.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., center processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090828, filed Jun. 4, 2024, which is hereby incorporated by reference herein in its entirety.

What is claimed is:

1. A video display apparatus comprising:
a display unit that displays a video; and
a support member configured to be connected to and rotatably support the display unit,
wherein the display unit and the support member are selectively attachable to each other at one of a plurality of positions.

2. The video display apparatus according to claim 1,
wherein the display unit includes a first connection unit,
wherein the support member includes a second connection unit, and
wherein the first connection unit and the second connection unit are configured such that the display unit and the support member are selectively attachable to each other at one among the plurality of discrete positions.

3. The video display apparatus according to claim 2,
wherein the first connection unit has a plurality of connection parts that are connected to the second connection unit, the connection parts being arranged in parallel in a depth direction with respect to a user, and
wherein the second connection unit is selectively attachable to each of the plurality of connection parts.

4. The video display apparatus according to claim 3, wherein a distance between the plurality of connection parts adjacent to each other in the first connection unit in the depth direction is within a range greater than 5 millimeters (mm) and less than 10 mm.

5. The video display apparatus according to claim 3, wherein the second connection unit includes an attachment unit that releasably attaches the first connection unit connected to the second connection unit.

6. The video display apparatus according to claim 3, further comprising:
a connection detection unit,
wherein the plurality of connection parts each includes a detection switch that comes into contact with the second connection unit in a case where the second connection unit is connected, and
wherein the connection detection unit detects connection of the second connection unit by the detection switch.

7. The video display apparatus according to claim 1, further comprising:
a determination unit configured to determine a current attachment position where the display unit and the support member are attached to each other; and
a notification unit configured to notify the current attachment position.

8. The video display apparatus according to claim 1, further comprising:
a face shape measurement unit configured to measure a face shape of a user; and
an attachment position recommending unit configured to recommend a predetermined attachment position where the display unit and the support member are attached to each other, based on a measurement result obtained by the face shape measurement unit.

9. The video display apparatus according to claim 1 further comprising:
a speaker disposed at the support member, and
wherein the speaker is configured to be adjustable in position in the support member.

10. The video display apparatus according to claim 1, wherein the support member is attached to a head of a user.

11. The video display apparatus according to claim 1, wherein the display unit is configured to be connectable to a handheld device that is held by a user, instead of the support member, and to detect connection of the handheld device.
